(19) United States
(12) Patent Application Publication
(10) Pub. No.: US 2017/0145223 A1
(43) Pub. Date: May 25, 2017

(54) Fireproof Composition and Use Thereof

(71) Applicant: Hilti Aktiengesellschaft, Schaan (LI)

(72) Inventors: Martin LANG, Planegg (DE); Sebastian SIMON, Buchloe Lindenberg (DE); Juliane MARAUSKA, Reutlingen (DE)

(21) Appl. No.: 15/318,859

(22) PCT Filed: Jun. 17, 2015
(86) PCT No.: PCT/EP2015/063538

§ 371 Date: Dec. 14, 2016

(30) Foreign Application Priority Data
Jun. 18, 2014 (EP) 14172909.5

(51) Int. Cl. C09D 5/18; C09D 181/02

(52) U.S. Cl. CPC C09D 5/18; C09D 181/02

(57) ABSTRACT

The invention relates to a composition which contains a binder based on thiol-ene. Said claimed composition makes it possible to apply, in a simple and rapid manner, coatings that have the layer thickness required for the respective fire resistance grading, the layer thickness being reduced to a minimum while achieving a good fire protection effect. Said claimed composition is particularly suitable for fire protection, especially as a coating for cables and cable routes for increasing the fire resistance grading.

The present invention relates to a composition, in particular an ablative composition which contains a binder based on thiol-ene as well as the use thereof for fire protection, in particular for the coating of components such as supports, beams, frame members, insulation systems, e.g. soft fittings, cables, cable bundles or cable routes for increasing the fire resistance grading.

In the case of fires, cable routes constitute particular points of danger for a number of reasons. On the one hand, in the case of fires of cables insulated with plastic, intensive smoke development occurs with the emission of harmful, in part toxic materials. On the other hand, a fire can quickly spread along cable routes and under certain circumstances the fire can be guided to a point that is far away from the original source of the fire. In the case of cable systems, there is also the problem that in the case of these cables the effect of the insulation decreases due to thermal impact or combustion and an interruption of the current flow can occur due to short-circuiting and thus the cables are destroyed or are not functional.

Electrical cables or lines are often laid in hallways and subdivided from there into the adjoining rooms. These hallways serve as escape and rescue routes in event of fire, which become unusable in the case of fires of cable installations due to smoke development and toxic fire gases, and e.g. burning PVC releases highly-corrosive gases. Large groups of cables thus constitute a significant risk potential, in particular in industrial construction, in power stations, in hospitals, large and administrative buildings and generally in buildings with high installation density. The cable insulations are often the relevant fire load in these buildings and cause fires lasting a long time with fire room temperatures in worst case scenarios up to over 1000° C. For the mentioned reasons, particular attention must be paid to cable routes with regard to fire protection measures.

In order to prevent, at least for a period of time, the dangers of the lack of functionality of the cables and the strong fire load increase by the cables, it is known to spatially separate the cables by non-flammable construction materials of the building material class A1 or A2 by laying the cables e.g. in installation and/or functional maintenance channels. However, this requires significant labor input. In addition, there is a high space requirement due to complex constructions which, in addition to the weight of the cable routes, must take into consideration the weight of the installation and/or maintenance channels. To this end, cables and cable routes are often wrapped with insulating materials such as aluminum oxide silica mats or mineral wool mats. In order to achieve sufficient fire protection, the material must be very thick. However, this leads to problems with respect to the distances between the protected object and adjacent or overlaid objects. Furthermore, these materials cause problems during normal operation due to their thermal insulating properties. One of these problems is termed “reduction of the current carrying capacity”. This means that the heat generated by electrical cables in the cable pipe or the cable route can no longer be dissipated in the region of the insulation, which leads to the secure current operating level permitted in these cables being reduced or overheating of the cables taking place. These disadvantages make this type of fire protection very inflexible with respect to the usage area thereof.

In order to avoid these disadvantages, it is also known to apply coatings for the protection of electrical cables which becomes intumescent with thermal impact in the event of fire, i.e. they foam and thus form an insulation layer or they receive heat due to physical and chemical processes and thus act in a cooling manner.

With intumescent coatings it is possible to prevent the involvement of cables in the event of fire for 30 minutes or longer. Coated cables of this type are often laid on cable routes. However, in this regard it has been shown that in the case of a vertical of the cable routes, a completely foamed insulation layer cannot prevent the spread of fire without additional measures. During heating, the cables between the cable clamps deforms so much that the coating forming the insulation layer tears and partially spalls. The resulting foam also comes loose from the cables and falls off. In the case of coating applied after laying the cables, the cables in the region of the clamp constructions are not fully accessible. As a result, in the case of a vertical or inclined arrangement of cable routes only foam of low thickness develops in the event of fire in the region of the clamp constructions, which is no longer sufficient as fire proofing for 30 minutes. In the case of laying PVC cables, the known problems in the event of fire thus occur again.

It is also known to use non-halogen cables provided in a flame-retardant or flame-resistant manner and which are flame-resistant and produce little smoke and have poor fire transfer properties. However, these cables are very expensive and are thus used only under extremely hazardous conditions.

In order to avoid the disadvantages of intumescent coatings, materials are applied to the cables and cable holders in cable routes, said materials exhibit an ablation effect, i.e. acting in a cooling manner under the influence of heat and becoming ceramic, as described for example in DE 196 49 749 A1. A method is described herein for designing fire protection for flammable components or components that are a heat risk, and the components are provided with a coating which contains, as the binder, an inorganic material made of finely-ground hydraulic binders such as calcium silicate, calcium aluminate or calcium ferrite, to which is added ablative materials such as aluminum or magnesium hydroxide. What is disadvantageous with this measure is that, on the one hand, the application of the material exhibiting the ablation effect is time-consuming and, on the other hand, the adherence of the material to the cables and to the cable holders poses a problem.

Other coating systems currently available on the market, which do not have some of the above-mentioned disadvantages, are single-component coating compositions on the basis of polymer dispersions which contain endothermically decomposing compounds. What is disadvantageous with these coatings is, on the one hand, the relatively long drying time of the coating and associated low dry layer thickness since these systems dry physically, i.e. through the evaporation of the solvent. A plurality of successive applications is thus required for thicker coatings, which also makes these systems time-consuming and labor intensive and thus uneconomical.

The object therefore underlying the invention is to provide an ablative coating system of the type mentioned at the outset which avoids the mentioned disadvantages which is in particular not solvent or water-based and has rapid hardening, is easy to apply owing to correspondingly adapted viscosity and requires only low layer thickness owing to the achievable high degree of filling.

This object is achieved by the composition according to claim 1. Preferred embodiments can be inferred from the dependent claims.

The subject matter of the invention is therefore a fire protection composition having a constituent A, which contains at least one compound having one or more reactive carbon multiple bonds such as a C—C double bond or a C—C triple bond per molecule and optionally at least one reactive diluent, having a constituent B, which contains at least one thiol-functionalized compound, the average number of thiol groups per molecule thereof is at least 2, and a radical initiator and having a constituent C, which contains at least one ablative fire protection additive.

Coatings with the layer thickness required for the respective fire resistance grading can be more easily and quickly applied by means of the composition according to the invention. The advantages achieved by means of the invention are substantially to be seen by the fact that in comparison to the systems on a solvent or water basis with their inherent long hardening times, the working time can be significantly reduced.

A further advantage is that the composition according to the invention can have a high degree of filling with the fire protection additive such that even with thin layers a strong insulating effect is achieved. The possible high degree of filling of the composition can be achieved even without the use of slightly volatile solvents. Accordingly, the material input reduces, which has a favorable effect on the material costs in particular in the case of an extensive application. This is achieved in particular by the use of a reactive system which does not dry physically, but rather hardens chemically via an addition reaction. The compositions thus do not suffer from any volume loss through the drying of solvents or of water in the case of water-based systems. A solvent content of approximately 25% is thus typical in the case of a classic system. This means that from a 10 mm wet film layer, only 7.5 mm remains on the substrate to be protected as the actual protective layer. In the case of the composition according to the invention, more than 95% of the coating remains on the substrate to be protected.

In the event of fire, the binder softens and the fire protection additives contained therein decompose depending on the additives used in an endothermic physical or chemical reaction with the development of water and inert gases, which, on the one hand, leads to the cooling of the cables and, on the other hand, to the diluting of the flammable gases or through the formation of a protective layer which protects the substrate from heat and attack by oxygen and, on the other hand, prevents the spreading of the fire through the combustion of the coating.

The compositions according to the invention exhibit excellent adherence to different subgrades compared to solvent or water-based systems if these are applied without primer such that they can be used universally and adhere not only to lines to be protected, but also to other carrier materials.

In order to improve the understanding of the invention, the following explanations of the terminology used herein are considered useful. In the context of the invention:
a “reactive C—C double bond or C—C triple bond” is a C—C double or triple bond which is not aromatic;
“ablative” means that in the case of the impact of high temperatures, i.e. above 200° C., as can occur for example in the event of fire, a series of chemical and physical reactions takes place, which require energy in the form of heat, and this energy is removed from the environment; this term is used synonymously with the term “endothermically decomposing”;
“reactive diluents” aqueous or low-viscous compounds (resins) which dilute other compounds (resins) with higher viscosity and as a result impart the viscosity required for the applications thereof, they contain functional groups capable of reacting with the base resin and are for the most part a component of the hardened composition in the case of polymerization (hardening);
“radical initiator” is a radical source which decays in a radiation-induced manner, thermally or by means of a catalyst (accelerator) with the formation of radicals;
“(meth)acryl . . . / . . . (meth)actyl . . . ” means that both “methacryl . . . / . . . methacryl . . . ” and “acryl . . . / . . . acryl . . . ” compounds should be included.

Expediently a compound having at least a C—C double bond or a C—C triple bond is used as the compound with reactive carbon multiple bonds, which can radically harden and is sufficiently stable in terms of storage due to the absence of homopolymerization. Suitable compounds are described in WO 2005/100436 A1 and WO 2007/042199 A1, the content of which is hereby included in this application.

According to a preferred embodiment of the invention, the compound having reactive carbon multiple bonds is a compound having at least one non-aromatic C—C double bond such as (meth)acrylate-functionalized compounds, allyl-functionalized compounds, vinyl-functionalized compounds, norbornene-functionalized compounds and unsaturated polyester compounds.

Examples of unsaturated polyester compounds can be inferred from the article by M. Maik et al. J. Macromol. Sci., Rev. Macromol. Chem. Phys. 2000, C40, 139-165, in which a classification of such compounds on the basis of their structure has been made, and five groups are mentioned: (1) ortho-resins, (2) iso-resins, (3) bisphenol A fumarates, (4) chlorendics and (5) vinyl ester resins. The so-called dicyclopentadiene (DCPD) resins can also be distinguished therefrom.

Further preferably the compound having reactive carbon multiple bonds has allyl-vinyl-, (meth)acryl-, fumaric acid, maleic acid, itaconic acid, crotonic acid or cinnamic acid double bond units or the compound having reactive carbon multiple bonds is a diels-alder adduct or a norborene derivative thereof or a derivative thereof having a different compound which carries the bicyclic double bonds. Exemplary compounds are vinyl esters, ally esters, vinyl ethers, allyl ethers, vinyl amines, allyl amines, vinyl amides, esters and amides of (meth)acrylic acid, esters of fumaric acid and maleimides.

Particularly preferred is the unsaturated compound selected from the group consisting of trimethylolpropane diallyl ether, pentaerythritol triallyl ether, pentaerythritol triacrylate, trimethylolpropane triacrylate, trimethylolpropane diallyl ether, phthalic acid diallyl ester, succinic acid diallyl ester, bernstein acid bis[4-(vinyloxy)butyl]ester, adipic acid bis[4-(vinyloxy)butyl]ester, isophthalic acid bis[4-(vinyloxy)butyl]ester, terephthalic acid bis[4-(vinyloxy)butyl]ester, trimellitic acid tris[4-(vinyloxy)butyl]ester, diethylene glycol vinyl ether, 1,4-cyclohexane dimethanol divinyl ether, 1,4-butanediol divinyl ether, pentaerythritol allyl ether, 1,3,5-triallyl-1,3,5-triazine-2,4,6-trione and triallylamine.

Particularly preferred as the compound having reactive carbon multiple bonds are compounds which are aqueous or have a low base viscosity (η<5 Pa s (T=23° C.; ý=300 s¹), measured according to DIN 53019-1) in order to ensure the low viscosity of the filled composition. In the case of higher or high-viscose compounds, the addition of a reactive diluent is required so that the viscosity of the composition as a whole remains low in the shear region of pumping and spraying.

In an embodiment of the invention, the composition thus contains further low-viscose compounds as reactive diluents in order to adapt the viscosity of the composition, if required. As reactive diluents, low-viscose compounds can be used as pure substances or in a mixture which react with the constituents of the composition. Examples are allyl ether, allyl ester, vinyl ether, vinyl ester, (meth)acrylic acid ester and thiol-functionalized compounds. Reactive diluents are preferably selected from the group consisting of allyl ethers such as allyl ethyl ether, ally propyl ether, allyl butyl ether, allyl phenyl ether, allyl benzyl ether, trimethylolpropane allyl ether, allyl esters such as acetic acid allyl ester, butyric acid allyl ester, maleic acid diallyl ester, allyl acetoacetate, vinyl ethers, such as butyl vinyl ether, 1,4-butanediol vinyl ether, tert-butyl vinyl ether, 2-ethylhexyl vinyl ether, cyclohexyl vinyl ether, 1,4-cyclohexane dimethanol vinyl ether, ethylene glycol vinyl ether, diethylene glycol vinyl ether, ethyl vinyl ether, isobutyl vinyl ether, propyl vinyl ether, ethyl-1-propenyl ether, dodecyl vinyl ether, hydroxypropyl (meth)acrylate, 1,2-ethanediol di(meth)acrylate, 1,3-propanediol di(meth)acrylate, 1,2-butanediol di(meth)acrylate, 1,4-butanediol di(meth)acrylate, trimethylolpropane tri(meth)acrylate, phenethyl (meth)acrylate, tetrahydrofurfuryl (meth)acrylate, ethyl triglycol (meth)acrylate, N,N-dimethylaminoethyl (meth)acrylate, acetoacetoxyethyl (meth)acrylate, isobornyl (meth)acrylate, 2-ethylhexyl (meth)acrylate, diethylene glycol di(meth)acrylate, methoxypolyethylene glycol mono(meth)acrylate, trimethylcyclohexyl (meth)acrylate, 2-hydroxyethyl (meth)acrylate, dicyclopentenyl oxyethyl (meth)acrylate and/or tricyclopentadienyl di(meth)acrylate, bisphenol-A-(meth)acrylate, novolac epoxy di(meth)acrylate, di-[(meth)acryloyl-maleoyl]-tricyclo-5.2.1.0.^{2.6}-decane, dicyclopentenyl oxy ethyl crotonate, 3-(meth)acryloyl-oxymethyl-tricylo-5.2.1.0.^{2.6}-decane, 3-(meth)cyclopentadienyl (meth)acrylate, isobornyl (meth)acrylate and decalyl-2-(meth)acrylate.

Other conventional compounds having reactive double bonds can essentially also be used alone or in the mixture with the (meth)acrylic acid esters, e.g. styrene, α-methylstyrene, alkylated styrenes, such as tert-butylstyrene, divinyl benzene and allyl compounds.

The degree of crosslinking of the binder and thus, on the one hand, the strength of the resulting coating as well as the elastic properties thereof can be set depending on the functionality of the epoxide resin.

In a preferred embodiment of the invention, the compound having one or more reactive C—C double bonds or C—C triple bonds per molecule also contains a compound for preventing the premature polymerization of the unsaturated compound, the so-called stabilizer. According to the invention the inhibitors commonly used for a radically polymerizable compound are suitable as stabilizers. The stabilizers are preferably selected from phenolic compounds and non-phenolic compounds, such as stable radicals and/or phenothiazines.

Phenolic inhibitors, which are often constituents of commercial radically hardening reaction resins, are considered phenols such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, pyrocatechol and butyl pyrocatechols, such as 4-tert-butyl pyrocatechol, 4,6-di-tert-butyl pyrocatechol, hydroquinones, such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methyl benzoquinone, 2,6-dimethyl benzoquinone, naphthoquinone or mixtures of two or more thereof.

Phenothiazines such as phenothiazine and/or derivatives or combinations thereof or stable organic radicals such as galvinoxyl and N-oxyl radicals are preferably considered as non-phenolic or anaerobic inhibitors, i.e. unlike the phenolic inhibitors, inhibitors that are also effective without oxygen.

N-oxyl radicals can be used such as those described in DE 199 56 509. Suitable stable N-oxyl radicals (nitroxyl radicals) may be selected from 1-oxyl-2,2,6,6-tetramethylpiperidine, 1-oxyl-2,2,6,6-tetramethylpiperidine-4-ol (also referred to as TEMPOL), 1-oxyl-2,2,6,6-tetramethylpiperidine-4-on (also referred to as TEMPON), 1-oxyl-2,2,6,6-tetramethyl-4-carboxyl-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, diethyl hydroxylamine. In addition, suitable N-oxyl compounds are oximes such as acetaldoxime, acetone oxime, methyl ethyl ketoxime, salicyloxime, benzoxime, glyoximes, dimethylglyoxime, acetone-O-(benzyloxycarbonyl) oxime or pyrimidinol or pyridinol compounds substituted in para-position for the hydroxyl group, as they are described in the non-pre-published patent specification DE 10 2011 077 248 B1, and the like.

The inhibitors can be used either alone or as a combination of two or more thereof.

Expediently, any compound that has at least two thiol groups, can be used as the thiol-functionalized compound. Each thiol group is in this regard bonded either directly or via a linker to a skeleton, and the thiol-functionalized compound of the present invention can have any wide number of skeletons, and these can be identical or different.

According to the invention, the skeleton is a monomer, an oligomer or a polymer.

In some embodiments of the present invention, the skeletons have monomers, oligomers or polymers with a molecular weight (MW) of 50,000 g/mol or less, preferably 25,000 g/mol or less, more preferably 10,000 g/mol or less, even more preferably 5,000 g/mol or less, even more preferably 2,000 g/mol or less and most preferably 1,000 g/mol or less.

As monomers which are suitable as skeletons, alkanediols, alkylene glycols, sugars, polyvalent derivatives thereof or mixtures thereof and amines, such as ethylene diamines and hexamethylene diamines and thiols can be mentioned by way of example. As oligomers or polymers which are suitable as skeletons, the following can be mentioned by way of example: polyalkylene oxide, polyurethane, polyethylene vinyl acetate, polyvinyl alcohol, polydiene, hydrogenated polydiene, alkyd, alkyd polyester, (meth)acrylic polymer, polyolefin, polyester, halogenated polyolefin, halogenated polyester, polymercaptan, as well as copolymers or the mixtures thereof.

In preferred embodiments of the invention, the skeleton is a polyvalent alcohol or a polyvalent amine, and these can be monomer, oligomer or polymer in nature. More preferably, the skeleton is a polyvalent alcohol.

As polyvalent alcohols which are suitable as skeletons, the following can be mentioned by way of example: alkanediols, such as butanediol, pentanediol, hexanediol, alkylene glycol, such as ethylene glycol, propylene glycol and polypropylene glycol, glycerin, 2-(hydroxymethyl)propane-1,3-diol, 1,1,1-tris(hydroxymethyl)ethane, 1,1,1-trimethylolpropane, di(trimethylolpropane), tricyclodecane dimethylol, 2,2,4-trimethyl-1,3-pentanediol, bisphenol A, cyclohexane dimethanol, alkoxylated and/or ethoxylated and/or propoxylated derivatives of neopentyl glycol, tertraethylene glycol cyclohexane dimethanol, hexanediol, 2-(hydroxylmethy)propane-1,3-diol, 1,1,1-tris(hydroxymethyl)ethane, 1,1,1-trimethylolpropane and castor oil, pentaerythritol, sugars, polyvalent derivatives thereof or mixtures thereof.

As linkers, any units, which are suitable, can be used to connect skeleton and functional group. For thiol-functionalized compounds, the linker is preferably selected from the structures (I) to (XI).

1: Bond to functional group
2: Bond to skeleton

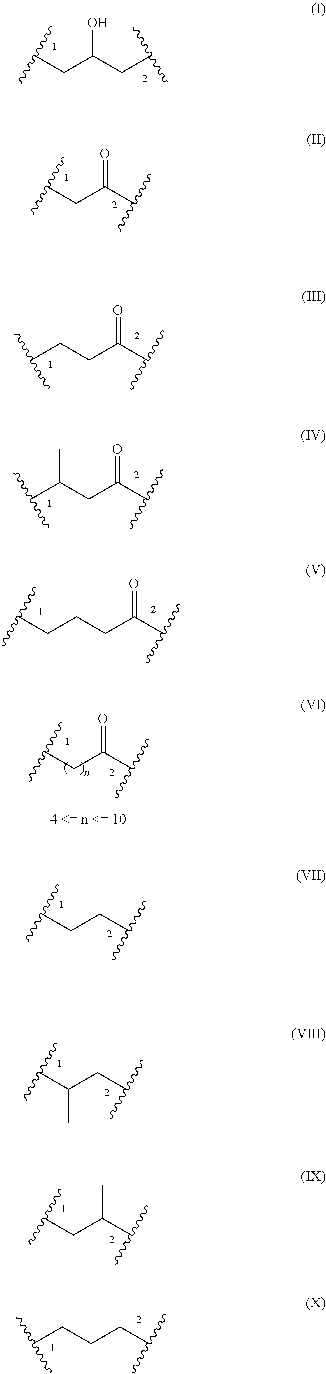

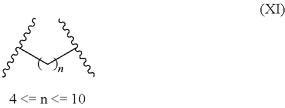

As linkers for thiol-functionalized compounds, the structures (I), (II), (III) and (IV) are preferred.

For thiol-functionalized compounds, the functional group is the thiol group (—SH).

Particularly preferred thiol-functionalized compounds are esters of the α-thioacetic acid (2-mercaptoacetate), p-thiopropionic acid (3-mercaptopropionate) and 3-thio butyric acid (3-mercaptobutyrate) with monoalcohols, diols, triols, tetraols, pentaols or other polyols as well as 2-hydroxy-3-mercaptopropyl derivatives of monoalcohols, diols, triols, tetraols, pentaols or other polyols. Mixtures of alcohols can also be used here as the basis for the thiol-functionalized compound. Reference is made in this respect to WO 99/51663 A1, the content of which is hereby included in this application.

As particularly suitable thiol-functionalized compounds, the following can be mentioned by way of example: glycol-bis(2-mercaptoacetate), glycol-bis(3-mercaptopropionate), 1,2-propyleneglycol-bis(2-mercaptoacetate), 1,2-propyleneglycol-bis(3-mercaptopropionate), 1,3-propyleneglycol-bis(2-mercaptoacetate), 1,3-propyleneglycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylolpropane-tri(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptopropionate), pentaerythritol-tris(3-mercaptobutyrate), pentaerythritol-tetrakis(3-mercaptobutyrate), Capcure 3-800 (BASF), GPM-800 (Gabriel Performance Products), Capcure® LOF (BASF), GPM-800LO (Gabriel Performance Products), KarenzMT PE-1 (Showa Denko), Cetepox 2200H (CTP), 2-ethylhexyl thioglycolate, iso-octyl thioglycolate, di(n-butyl)thiodiglycolate, glycol-di-3-mercaptopropionate, 1,6-hexanedithiol, ethyleneglycol-bis(2-mercaptoacetate) and tetra(ethyleneglycol)dithiol.

The thiol-functionalized compound can be used alone or as a mixture of two or more different thiol-functionalized compounds.

Similar to the compound having one or more reactive carbon multiple bonds, the degree of crosslinking of the binder and thus, on the one hand, the strength of the resulting coating and the elastic properties thereof, can be set depending on the functionality of the thiol compound.

The reaction between the at least one radically polymerizable compound having one or more reactive carbon multiple bonds and the at least one thiol-functionalized compound is started by a radical initiator.

In this regard, all compounds known to the person skilled in the art, which form radicals in a radiation-induced manner, by thermal or catalytic decay, are considered radical initiators.

The radical initiator is preferably a compound that forms radicals by thermal or catalytic decay. The radical initiator is particularly preferably a compound which forms radicals by catalytic decay.

Examples of photo initiators include benzoin and substituted derivatives thereof, benzophenones, 4,4′-bis(dimethylamino)benzophenone, dialkoxy benzophenones, dialkoxy acetophenones, peroxyesters, such as for example as are described in U.S. Pat. Nos. 4,616,826 and 4,604,295. The following compounds can be mentioned by way of example: benzophenone, acetophenone, acenapthenequinone, o-methoxybenzophenone, thioxanthen-9-one, xanthen-9-one, 7H-benz[de]anthracen-7-one, dibenzosuberone, 1-naphthaldehyde, 4,4′-bis(di methylamino)benzophenone, fluoren-9-one, 1′-acetonaphthone, 2′-acetonapththone, anthraquinone, 1-indanone, 2-tert-butyl anthraquinone, valerophenone, hexanophenone, 8-phenyl butyrophenone, p-morpholino propiophenone, 4-morpholinobenzophenone, 4′-morpholinodeoxybenzoin-p-diacetylbenzene, 4′-methoxyacetophenone, benzaldehyde, 9-acetyl phenanthrene, 2-acetylphenanthrene, 10-thioxanthene, 3-acetylphenanthrene, 3-acetylindole, 1,3,5-triacetylbenzene and mixtures thereof.

Thermal radical initiators include peroxides, azonitriles and similar radical initiators known to the person skilled in the art, and peroxides are preferred.

The peroxides used for initiating the hardening reaction can be any peroxides that are known to the person skilled in the art for use in hardening unsaturated compounds. Peroxides of this type contain organic and inorganic peroxides, either solid or liquid. Hydrogen peroxide can also be used. Examples of suitable peroxides are peroxy carbonates (of the formula —OC(O)OO—), peroxy esters (of the formula —C(O)OO—), diacyl peroxides (of the formula —C(O)OOC(O)—), dialkyl peroxides (of the formula —OO—) and the like. They can also have an oligomer or polymer nature. A comprehensive range of examples of suitable peroxides can be found for example in US 2002/0091214 A1, paragraph [0018].

The peroxide is preferably a hydrogen peroxide, a perether, a perester, a peranhydride or a percarbonate, the peroxide is more preferably selected from the group of percarbonates, peresters and hydroperoxides and the peroxide is most preferably a monopercarbonate such as, for example, tert-butylperoxy-2-ethylhexyl carbonate or a perester such as, for example, tert-butylperoxy benzoate.

The composition according to the invention preferably also includes a transition metal compound as the accelerator or hardening catalyst. The presence of such a transition metal compound is advantageous to the extent that it accelerates the decomposition of the peroxide and thus the hardening of the resin composition. The transition metal is preferably selected from the transition metals, the atomic numbers thereof range from an atomic number in the range of 22 to 28 or an atomic number in the range of 38 to 49 or an atomic number in the range of 57 to 79. The transition metal is most preferably selected from V, Mn, Cu, Fe.

The compositions can also contain a co-accelerator such as 1,3-dicarbonyl compounds, e.g. 1,3-diketones and aldehydes, in particular acetylacetone, benzoylacetone and dibenzoylmethane; mono and diesters, particularly diethyl malonate and succinates, acetoacetates such as ethylacetoacetate, acetoxyacetyl ethyl methacrylate and the like in order to further increase the reactivity, if required.

The mode of action of the ablative composition according to the invention builds on an endothermic physical and/or chemical reaction, and materials, which require large quantities of energy for the decomposition thereof, are contained in the composition. If the hardened composition is exposed to high temperature, for example the temperature of a fire in the event of fire, a series of chemical and physical processes is initiated. These processes are, for example, the release of water vapor, change of the chemical composition and the development of inflammable gases, which maintain the oxygen required for combustion distanced from the cable surface. All these processes require a large quantity of energy, which is removed from the fire. After the conversion of all organic constituents has concluded, a stable insulation layer made of inorganic constituents is formed which has an additional insulation effect.

According to the invention, the constituent C thus contains at least one ablative fire protection additive, and both individual compounds and a mixture of a plurality of compounds can be used as the additive.

Expediently, such materials are used as ablative fire protection additives that form energy-absorbing layers by means of water separation, which is stored, for example, in the form of crystalline water, and water evaporation. The heat energy, which has to be expended in order to separate the water, is removed from the fire in this regard. Such materials are also used which chemically change or decompose, evaporate, sublime or melt in an endothermic reaction in the case of the influence of heat. As a result, the coated substrates are cooled. Inert, i.e. non-flammable gases such as carbon dioxide, are often released in the case of decomposition, which also dilutes the oxygen in the direct environment of the coated substrate.

Suitable gas-separating constituents are hydroxides such as aluminum hydroxide and magnesium hydroxide and the hydrates thereof, which separate water, and carbonates such as calcium carbonate, which separate carbon dioxide. Basic carbonates can separate both water and CO₂. A combination of constituents starting the gas separation at different temperatures is preferable. Thus in the case of aluminum hydroxide the water separation starts at approx. 200° C., whereas the water separation in the case of magnesium hydroxide starts at approx. 350° C. such that the gas separation takes place over a larger temperature range.

Suitable ablative materials are, in the case of the influence of heat, water-releasing inorganic hydroxides or hydrates such as sodium, potassium, lithium, barium, calcium, magnesium, boron, aluminum, zinc, nickel, also boric acid and the partly dewatered derivatives thereof.

The following compounds can be mentioned by way of example: LiNO₃.3H₂O, Na₂CO₃H₂O (thermonatrite), Na₂CO₃.7H₂O, Na₂CO₃.10H₂O (soda), Na₂Ca(CO₃)₂.2H₂O (pirssonite), Na₂Ca(CO₃)₂.5H₂O (gaylussite), Na(HCO₃)Na₂CO₃.2H₂O (trona), Na₂S₂O₃.5H₂O, Na₂O₃Si.5H₂O, KF.2H₂O, CaBr₂.2H₂O, CaBr₂.6H₂O, CaSO₄.2H₂O (gips), Ca(SO₄).½H₂O (bassanite), Ba(OH)₂.8H₂O, Ni(NO₃)₂.6H₂O, Ni(NO₃)₂.4H₂O, Ni(NO₃)₂.2H₂O, Zn(NO₃)₂.4H₂O, Zn(NO₃)₂.6H₂O, (ZnO)₂(B₂O₃)₂.3H₂O, Mg(NO₃)₂.6H₂O (U.S. Pat. No. 5,985,013 A), MgSO₄.7H₂O (EP1069172A), Mg(OH)₂, Al(OH)₃, Al(OH)₃.3H₂O, AlOOH (boehmite), Al₂[SO₄]₃.nH₂O with n=14-18 (U.S. Pat. No. 4,462,831 B), optionally in the mixture with AlNH₄(SO₄)₂.12H₂O (U.S. Pat. No. 5,104,917A), KAl(SO₄)₂.12H₂O (EP1069172A), CaO Al₂O₃.10H₂O (nesquehonite), MgCO₃.3H₂O (wermlandite), Ca₂Mg₁₄(Al₁Fe)₄CO₃(OH)₄₂.29H₂O (thaumasite), Ca₃Si(OH)₆(SO₄)(CO₃).12H₂O (artinite), Mg₂(OH)₂CO₃—H₂O (ettringite), 3CaO Al₂O₃.3CaSO₄.32H₂O (hydromagnesite), Mg₅(OH)₂(CO₃)₄.4H₂O (hydrocalumite) Ca₄Al₂(OH)₁₄.6H₂O (hydrotalkite), Mg₆Al₂(OH)₁₆CO₃.4H₂O alumohydrocalcite, CaAl₂(OH)₄(CO₃)₂.3H₂O scarbroite, Al₁₄(CO₃)₃(OH)₃₆ hydrogranate, 3CaO Al₂O₃.6H₂O dawsonite, NaAl(OH)CO₃, water-containing zeolites, vermiculites, colemanite, perlites, mica, alkaline silicates, borax, modified carbons and graphites, silicic acids.

In a preferred embodiment, the hydrated salts are selected from the group consisting of Al₂(SO₄).16-18H₂O, NH₄Fe(SO₄)₂.12H₂O, Na₂B₄O₇.10H₂O, NaAl(SO₄)₂.12H₂O, AlNH₄(SO₄)₂.12-24H₂O, Na₂SO₄.10H₂O, MgSO₄.7H₂O, (NH₄)₂SO₄.12H₂O; KAl(SO₄)₂.12H₂O, Na₂SiO₃.9H₂O, Mg(NO₂)₂.6H₂O, Na₂CO₃.7H₂O and mixtures thereof (EP1069172A).

Particularly preferred are aluminum dioxide, aluminum hydroxide hydrates, magnesium hydroxide and zinc borate since they have an activation temperature below 180° C.

One or more reactive flame retardants can be optionally added to the composition according to the invention. Compounds of this type are incorporated into the binder. An example in the context of the invention are reactive organophosphorus compounds such as 9,10-dihydro-9-oxa-10-phosphaphenanthrene-10-oxide (DOPO) and the derivatives thereof, such as for example DOPO-HQ, DOPO-NQ and adducts. Such compounds are for example described in S. V. Levchik, E. D. Weil, Polym. Int 2004, 53, 1901-1929.

The ablative fire protection additive can be contained in a quantity of 5 to 99 wt % in the composition, and the quantity substantially depends on the form of application of the composition (spraying, painting and the like). In order to effect the best insulation possible, the proportion of the constituent C in the total formulation is set to be as high as possible. The proportion of the constituent C in the total formulation is preferably 5 to 85 wt % and particularly preferably 40 to 80 wt %.

The composition can contain, in addition to the intumescent additives, optionally conventional excipients, such as solvents, for example, xylol or toluene, wetting agents, for example, on the basis of polyacrylates and/or polyphosphates, defoamers, for example, silicon defoamers, thickeners, for example, alginate thickeners, colorants, fungicides, Softeners, for example, chlorinated waxes, binders, flame retardants or various fillers, for example, vermiculite, inorganic fibers, quartz sand, micro glass beads, mica, silicon dioxide, mineral wool and the like.

Additional additives such as thickeners, rheological additives and fillers can be added to the composition. As rheological additives, for example, anti-setting agents, anti-sag agents and thixotropic agents, the following are preferably used, polyhydroxy carbonic acid amides, urea derivatives, salts of unsaturated carbonic acid esters, alkyl ammonium salts of acidic phosphoric acid derivatives, ketoximes, amine salts of p-toluene sulfonic acid, amine salts of sulfonic acid derivatives, as well as aqueous or organic solutions or mixtures of the compounds. Rheology additives on the basis of pyrogenic or precipitated silicic acids or on the basis of silanized pyrogenic or precipitated silicic acids can also be used. The rheology additive is preferably pyrogenic silicic acids, modified and unmodified layer silicates, precipitated silicic acids, cellulose ethers, polysaccharides, PU and acrylate thickeners, urea derivatives, castor oil derivatives, polyamides, and fatty acid amides and polyolefins, if present in solid form, pulverized celluloses and/or suspension agents, such as, for example, xanthan gum.

The composition according to the invention can be made as a two-component system or multicomponent system.

In a preferred embodiment of the invention, the composition according to the invention is made as a two-component system, and the constituent A and the constituent B are arranged separated in a reaction-inhibiting manner. Accordingly, a first component, which is component I, contains the constituent A and a second component, which is component II, contains the constituent B. This ensures that the two constituents A and B of the binder are mixed together only directly prior to the application and trigger the hardening reaction. This makes the system easier to use.

The unsaturated compound is, in this regard, preferably contained in the component I in a quantity of 2 to 95 wt %.

If a reactive diluent is used, then it is contained in the component I in a quantity of 90 to 10 wt %, preferably 70 to 10 wt %.

The thiol-functionalized compound is preferably contained in the component II in a quantity of 0.5 to 90 wt %, more preferably in a quantity of 2 to 85 wt % and most preferably in a quantity of 4 to 75 wt %.

If an inhibitor is used, it can be contained in the component I in a quantity of 0.001 to 1 wt %, preferably 0.01 to 0.5 wt % and more preferably 0.03 to 0.35 wt %, based on the compound with reactive carbon multiple bonds having one or more reactive C—C double bonds or C—C triple bonds per molecule (constituent A).

If the radical initiator is a mixture of a peroxide, an accelerator and optionally a co-accelerator or catalyst, the accelerator and the co-accelerator or the catalyst are thus arranged in a reaction-inhibiting manner separated from the peroxide. In the case of the preferred two-component system, this means that the accelerator and optionally the co-accelerator or the catalyst are contained in the component I together with the constituent A.

The two-component system preferably includes the constituent A and the constituent B separated in different containers in a reaction-inhibiting manner, for example in a multi-chamber device, such as, for example, a multi-chamber cartridge, from which containers the two components are pressed out and mixed through the action of mechanical pressing forces or the action of a gas pressure.

The constituent C can, in this regard, be contained as a total mixture or, provided a plurality of compound is contained, in individual constituents distributed in a first component I and/or in a second component II. The distribution of the constituent C takes place depending on the compatibility of the compounds contained in the composition, such that neither a reaction between the compounds contained in the composition or a reciprocal disruption nor a reaction of these compounds with the compounds of other components can take place. This is dependent on the compounds used.

The composition is applied as a paste with a paintbrush, a roller or by spraying onto the substrate. The substrate can be metallic or consist of another, non-metallic material such as, for example, plastic in the case of cables or of mineral wool in the case of soft fittings or of a material combination, for example, of metallic and non-metallic materials such as in the case of cable routes. The composition is preferably applied by means of an airless spraying method.

The composition according to the invention, in comparison to the solvent and water-based systems, is characterized by a relatively rapid hardening by means of an addition reaction and thus physical drying is not required. This is, in particular very important if the coated constituents have to be quickly loaded or further processed, whether it be by coating with a cover layer or moving or transporting the constituents. The coating is thus also notably less susceptible to external influences on the construction site, such as, e.g., impact from (rain)water or dust or dirt which, in the case of solvent or water-based systems, may lead to a leaching out of water-soluble constituents, or, in the case of dust accumulation, to a reduced ablative effect. The composition remains simple to process in particular, using common spray methods because of the low viscosity of the composition despite the high solid content, which can be up to 99 wt % in the composition without the addition of slightly volatile solvent.

In this regard, the composition according to the invention is suitable, in particular as fire protection coating, in particular sprayable coating for constituents on a metallic and non-metallic basis. The composition according to the invention can be used in particular in the field of construction as a coating, in particular as fire protection coating for individual cables, cable bundles, cable routes and cable channels or other lines as well as fire protection coating for steel construction elements, but also for construction elements made from other materials such as concrete or wood.

A further subject matter of the invention is therefore the use of the composition according to the invention as a coating, in particular as a coating for construction elements or structural elements made from steel, concrete, wood and other materials, such as, for example, plastics, in particular as fire protection coating for individual cables, cable bundles, cable routes and cable channels or other lines or soft fittings.

The present invention also relates to objects, which are obtained when the composition according to the invention hardens. The objects have excellent ablative properties.

The following examples serve to further explain the invention.

### EXEMPLARY EMBODIMENTS

The following listed constituents are used for the manufacture of ablative compositions according to the invention. The individual constituents are respectively mixed and homogenized by means of a dissolver. For the application, these mixtures are then mixed and applied either prior to spraying or during spraying.

In order to determine the fire protection properties, the hardened composition was subjected to a test according to EN ISO 11925-2. The test is carried out in a draft-free Mitsubishi FR-D700SC electric inverter combustion chamber. In the test, a small burner flame is directed at an angle of 45° for 30 seconds on the sample surface that corresponds to surface ignition.

Samples with the dimensions 11 cm×29.5 cm and an application thickness of 2-3 mm are respectively used. These samples hardened at room temperature and were aged for three days at 40° C.

After aging for three days at 40° C., the test is carried out for ignitability and height of the attacked surface.

The hardening time and the hardening progress were determined. In this regard, it was tested with a spatula when the hardening of the coating started.

For the following examples 1 to 3, aluminum hydrate (HN 434 from the J. M Huber Corporation, Finland) was used as constituent C, and 18 g of said constituent were respectively used.

### Example 1

### Component A

| Constituent | Quantity [g] |
|---|---|
| Pentaerythritoltetra(3-mercaptopropionate) | 24.3 |
| Durcal 5¹⁾ | 36.0 |
| Trigonox ® C²⁾ | 1.8 |

¹⁾Calcium carbonate, ground
²⁾tert-butyl perbenzoate, 55% aqueous solution

### Component B

| Constituent | Quantity [g] |
|---|---|
| Tris-(4-[vinyloxy]butyl)trimellitate | 33.4 |
| Octa soligen manganese 10³⁾ | 0.3 |
| Acetoacetone | 0.3 |
| Tempol⁴⁾ | 0.005 |
| Durcal 5 | 36.0 |

³⁾Mn(II)-octoate
⁴⁾4-Hydroxy-2,2,6,6-tetramethylpiperidin-N-oxyl

### Example 2

### Component A

| Constituent | Quantity [g] |
|---|---|
| Trimethylolpropantri (3- | 35.1 |
| mercaptopropionate) | |
| Durcal 5 | 36.0 |
| Trigonox C | 1.7 |

### Component B

| Constituent | Quantity [g] |
|---|---|
| Pentaerythritol allyl ether | 22.6 |
| Octa-soligen manganese 10 | 0.3 |
| Acetoacetone | 0.3 |
| Tempol | 0.005 |
| Durcal 5 | 36.0 |

### Example 3

### Component A

| Constituent | Quantity [g] |
|---|---|
| Pentaerythritol(3-mercaptopropionate) | 32.0 |
| Durcal 5 | 36.0 |
| Trigonox C | 1.7 |

### Component B

| Constituent | Quantity [g] |
|---|---|
| 1.4-cyclohexanedimethanol divinyl ether | 25.7 |
| Octa-soligen manganese 10 | 0.3 |
| Acetoacetone | 0.3 |
| Tempol | 0.005 |
| Durcal 5 | 36.0 |

### Comparative Example 1

A commercial fire protection product (Hilti CFP S-WB) based on aqueous dispersion technology served as the comparison.

TABLE 1
Results of the determination of the hardening time, the ignition
and the flame height

| | Comparative | | | |
|---|---|---|---|---|
| Examples | example 1 | 1 | 2 | 3 |
| Hardening time | 24 h | <1 h | <1 h | <1 h |
| Ignition | Yes | Yes | Yes | Yes |
| Flame height | 150 mm | 40 mm | 41 mm | 44 mm |

1. A fire protection composition having a constituent A, which contains at least one compound having one or more reactive carbon multiple bonds per molecule, having a constituent B, which contains at least one thiol-functionalized compound, the average number of thiol groups per molecule thereof is at least 2, and a radical initiator and having a constituent C, which contains at least one ablative fire protection additive.

2. The composition according to claim 1, wherein the at least one compound having reactive carbon multiple bonds contains one or more C—C double bonds and is selected from vinyl esters, ally esters, vinyl ethers, allyl ethers, vinyl amines, allyl amines, vinyl amides, esters and amides of (meth)acrylic acid, esters of fumaric acid, maleimides.

3. The composition according to claim 2, wherein the at least one compound, which contains one or more C—C double bonds, is selected from trimethylolpropane diallyl ether, pentaerythritol triallyl ether, pentaerythritol triacrylate, trimethylolpropane triacrylate, trimethylolpropane diallyl ether, phthalic acid diallyl ester, succinic acid diallyl ester, bernstein acid bis[4-(vinyloxy)butyl]ester, adipic acid bis[4-(vinyloxy)butyl]ester, isophthalic acid bis[4-(vinyloxy)butyl]ester, terephthalic acid bis[4-(vinyloxy)butyl]ester, trimellitic acid tris[4-(vinyloxy)butyl]ester, diethylene glycol vinyl ether, 1,4-cyclohexane dimethanol divinyl ether, 1,4-butanediol divinyl ether, pentaerythritol allyl ether, 1,3,5-triallyl-1,3,5-triazine-2,4,6-trione and triallylamine.

4. The composition according to claim 1, wherein the at least one thiol-functionalized compound is a polythiol compound having at least three thiol groups per molecule.

5. The composition according to claim 1, wherein the thiol-functionalized compound is selected from the group consisting of glycol-bis(2-mercaptoacetate), glycol-bis(3-mercaptopropionate), 1,2-propyleneglycol-bis(2-mercaptoacetate), 1,2-propyleneglycol-bis(3-mercaptopropionate), 1,3-propyleneglycol-bis(2-mercaptoacetate), 1,3-propyleneglycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylolpropane-tris(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptopropionate), 2-ethylhexyl thioglycolate, iso-octyl thioglycolate, di(n-butyl)thiodiglycolate, glycol-di-3-mercaptopropionate, 1,6-hexanedithiol, ethyleneglycol-bis(2-mercaptoacetate) and tetra(ethyleneglycol)dithiol.

6. The composition according to claim 1, wherein the radical initiator is an inorganic or organic peroxide.

7. The composition according to claim 1, wherein the composition also contains a reactive diluent.

8. The composition according to claim 1, wherein the composition also contains an accelerator.

9. The composition according to claim 8, wherein the accelerator is a combination of a 1,3-dicarbonyl compound and a metal salt.

10. The composition according to claim 1, wherein the composition also contains an inhibitor.

11. The composition according to claim 1, wherein the at least one ablative fire protection additive is selected from the group consisting of LiNO3.3H2O, Na2CO3H2O (thermonatrite), Na2CO3.7H2O, Na2CO3.10H2O (soda), Na2Ca(CO3)2.2H2O (pirssonite), Na2Ca(CO3)2.5H2O (gaylussite), Na(HCO3)Na2CO3.2H2O (trona), Na2S2O3.5H2O, Na2O3 Si.5H2O, KF.2H2O, CaBr2.2H2O, CaBr2.6H2O, CaSO4.2H2O (gips), Ca(SO4).½H2O (bassanite), Ba(OH)2.8H2O, Ni(NO3)2.6H2O, Ni(NO3)2.4H2O, Ni(NO3)2.2H2O, Zn(NO3)2.4H2O, Zn(NO3)2.6H2O, (ZnO)2(B2O3)2.3H2O, Mg(NO3)2.6H2O (U.S. Pat. No. 5,985,013 A), MgSO4.7H2O (EP1069172A), Mg(OH)2, Al(OH)3, Al(OH)3.3H2O, AlOOH (boehmite), Al2[SO4]3 nH2O with n=14-18 (U.S. Pat. No. 4,462,831 B), optionally in the mixture with AINH4(SO4)2.12H2O (U.S. Pat. No. 5,104,917A), KAl(SO4)2.12H2O (EP1069172A), CaO Al2O3.10H2O (nesquehonite), MgCO3.3H2O (wermlandite), Ca2Mg14(Al1Fe)4CO3(OH)42.29H2O (thaumasite), Ca3Si(OH)6(SO4)(CO3).12H2O (artinite), Mg2(OH)2CO3.H2O (ettringite), 3CaO.Al2O3.3CaSO4.32H2O (hydromagnesite), Mg5(OH)2(CO3)4.4H2O (hydrocalumite) Ca4Al2(OH)14.6H2O (hydrotalkite), Mg6Al2(OH)16CO3.4H2O alumohydrocalcite, CaAl2(OH)4(CO3)2.3H2O scarbroite, Al14(CO3)3(OH)36 hydrogranate, 3CaO.Al2O3.6H2O dawsonite, NaAl(OH)CO3, water-containing zeolites, vermiculites, colemanite, perlites, mica, alkaline silicates, borax, modified carbons, graphites, silicic acids and mixtures thereof.

12. The composition according to claim 1, wherein the composition also contains organic and/or inorganic aggregates and/or further additives.

13. The composition according to claim 1, wherein the component is made as a two-component or multicomponent system.

14. A use of the composition according to claim 1 as a coating.

15. The use according to claim 14 for the coating of construction elements.

16. The use according to claim 14 for the coating of non-metallic components.

17. The use according to claim 14 as a fire protection layer, in particular for individual cables, cable bundles, cable routes and cable channels or other lines or soft fittings.

18. Hardened objects obtained by hardening the composition according to claim 1.
